(19) United States
(12) Patent Application Publication
(10) Pub. No.: US 2026/0237277 A1
(43) Pub. Date: Aug. 13, 2026

(54) ALARM SYSTEM, ALARM METHOD, AND RECORDING MEDIUM

(71) Applicants: NEC Platforms, Ltd., Kanagawa (JP); NEC Corporation, Tokyo (JP)

(72) Inventors: Shinji OGURI, Kanagawa (JP); Asakeo TOYOTA, Kanagawa (JP); Susumu ONOHARA, Kanagawa (JP); Hiroyuki KAWAMOTO, Kanagawa (JP); Tetsuya MIHIRA, Kanagawa (JP); Hiroki SUGEGAYA, Kanagawa (JP)

(73) Assignees: NEC Platforms, Ltd., Kanagawa (JP); NEC Corporation, Tokyo (JP)

(21) Appl. No.: 19/152,487

(22) PCT Filed: Feb. 9, 2023
(86) PCT No.: PCT/JP2023/004412

§ 371 Date: Jul. 31, 2025

(51) Int. Cl. G08B 13/24

(52) U.S. Cl. CPC G08B 13/2434; G08B 13/2417

(57) ABSTRACT

An alarm system include: at least one memory storing instructions; and at least one processor configured to execute the instructions to: detect, by a reading device installed in a store, a position of a price label tag attached to a product and including a first radio frequency identification (RFID) tag that stores product identification information of the product, and a position of a spare tag attached to the product and including a second RFID tag; determine whether the position of the price label tag and the position of the spare tag match; and issue an alarm in a case where the position of the price label tag and the position of the spare tag do not match.

### TECHNICAL FIELD

The present disclosure relates to an alarm system and the like.

### BACKGROUND ART

There is a technique in which a radio frequency identification (RFID) tag is provided between sheets of price label tags of clothing products such as clothes, hats, bags, and shoes, the RFID tag stores information for identifying the product, and the RFID tag is used for checkout.

### CITATION LIST

### Patent Literature

PTL 1: WO 2020/208412 A1

### SUMMARY OF INVENTION

### Technical Problem

For example, there is a problem of shoplifting in which a customer removes a price label tag from a product and brings the product back.

An object of the present disclosure is to provide an alarm system and the like for suppressing shoplifting.

### Solution to Problem

An alarm system according to one aspect of the present disclosure includes a position detection means for detecting, by a reading device installed in a store, a position of a price label tag attached to a product and including a first RFID tag that stores product identification information of the product, and a position of a spare tag attached to the product and including a second RFID tag, a determination means for determining whether the position of the price label tag and the position of the spare tag match, and an output control means for issuing alarm in a case where the positions do not match.

An alarm method according to one aspect of the present disclosure includes detecting, by a reading device installed in a store, a position of a price label tag attached to a product and including a first RFID tag that stores product identification information of the product and a position of a spare tag attached to the product and including a second RFID tag, determining whether the position of the price label tag and the position of the spare tag match, and issuing an alarm in a case where the positions do not match.

A program according to one aspect of the present disclosure causes a computer to execute processing of detecting, by a reading device installed in a store, a position of a price label tag attached to a product and including a first RFID tag that stores product identification information of the product and a position of a spare tag attached to the product and including a second RFID tag, determining whether the position of the price label tag matches the position of the spare tag, and issuing an alarm in a case where the positions do not match.

The program may be stored in a non-transitory computer-readable recording medium.

### Advantageous Effects of Invention

According to the present disclosure, shoplifting can be suppressed.

### BRIEF DESCRIPTION OF DRAWINGS

FIG. 1 is a block diagram illustrating a configuration example of an alarm system according to a first example embodiment.

FIG. 2 is a flowchart illustrating an operation example of the alarm system according to the first example embodiment.

FIG. 3 is an explanatory diagram illustrating an installation example of a plurality of reading devices and a plurality of image capturing devices in a store.

FIG. 4 is an explanatory diagram illustrating an example of connection between the alarm system and another device.

FIG. 5 is an explanatory diagram illustrating a storage example of a first RFID tag and a second RFID tag.

FIG. 6 is a block diagram illustrating a configuration example of an alarm system according to a second example embodiment.

FIG. 7 is an explanatory view showing an example in which a position of a price label tag and a position of a spare tag match.

FIG. 8 is an explanatory view showing an example in which the position of a price label tag does not match the position of a spare tag.

FIG. 9 is an explanatory diagram illustrating an example of issuing an alarm at a gate of an entrance.

FIG. 10A is an explanatory diagram illustrating an example of alarm to a terminal device of a clerk.

FIG. 10B is an explanatory diagram illustrating an example of alarm to the terminal device of the clerk.

FIG. 11A is an explanatory diagram illustrating an example of displaying traffic lines of customers.

FIG. 11B is an explanatory diagram illustrating an example of displaying traffic lines of customers.

FIG. 12 is a flowchart illustrating an operation example of the alarm system according to the second example embodiment.

FIG. 13 is an explanatory diagram illustrating a hardware configuration example of a computer.

### EXAMPLE EMBODIMENT

Hereinafter, example embodiments of an alarm system, an alarm method, a program, and a non-transitory recording medium recording the program according to the present disclosure will be described in detail with reference to the drawings. The present example embodiments does not limit the disclosed technology.

### First Example Embodiment

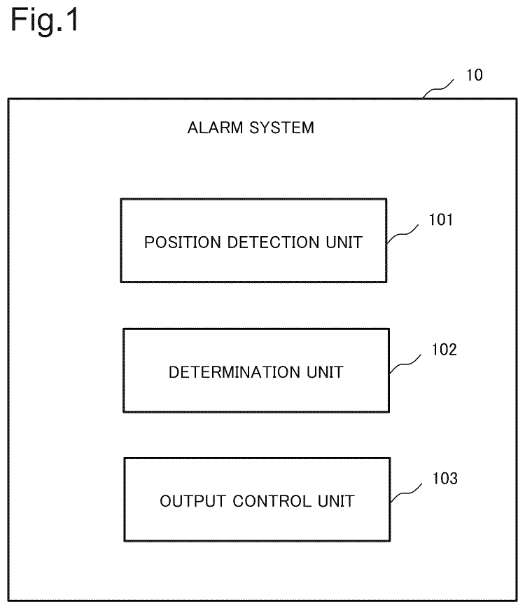

First, in a first example embodiment, a basic function of an alarm system will be described. FIG. 1 is a block diagram illustrating a configuration example of an alarm system according to the first example embodiment. An alarm system 10 includes a position detection unit 101, a determination unit 102, and an output control unit 103.

For example, a price label tag including a first radio frequency identification (RFID) tag storing product identification information of a product and a spare tag including a second RFID tag are attached to the product.

The price label tag is a tag that is removable from the product. The spare tag may be a tag that cannot be removed from the product, or may be a removable tag. For example, the spare tag may be a laundry tag or a clothes tag. The spare tag may be, for example, a button type tag made of resin or a tag made of fiber.

The position detection unit 101 detects the position of the price label tag and the position of the spare tag by a reading device installed in the store. The number of reading devices is not particularly limited. For example, a plurality of reading devices may be installed in a store. For example, the plurality of reading devices are installed at different positions in a store. The reading device is installed, for example, on a ceiling, a wall, a mirror, a gate, or the like. For example, the reading device may be installed at an entrance of a store. The reading device can obtain, for example, the received signal strength of the radio wave from the RDID tag. The position detection unit 101 can detect the position of the price label tag and the position of the spare tag based on the received signal strength. If a plurality of reading devices is installed at different positions in a store, the position of the price label tag and the position of the spare tag in the store can be detected more accurately. The position detection unit 101 is not limited to detecting the position of the tag including the RFID, and it is sufficient that the position detection unit can detect information related to the position of the tag including the RFID, such as received signal strength.

The determination unit 102 determines whether the position of the price label tag matches the position of the spare tag. In order to prevent shoplifting in which the price label tag is removed from the product and the product is taken away, the determination unit 102 only needs to be able to determine that the price label tag and the spare tag are attached to the product. Thus, if there are a price label tag and a spare tag within a predetermined range, the determination unit 102 may determine that the position of the price label tag matches the position of the spare tag. As a specific example of a method for determining matching, the determination unit 102 may determine that the position of the price label tag and the position of the spare tag match if the difference between the received signal strength of the signal from the price label tag and the received signal strength of the signal from the spare tag is within a threshold in the reading device. As a specific example of the matching determination method, when a plurality of reading devices is installed in a store, the determination unit 102 may determine that the position of the price label tag and the position of the spare tag match if the reading devices having the highest received signal strength are the same. In this way, the determination unit 102 may not determine a perfect match between the position of the price label tag and the position of the spare tag.

In a case where those positions do not match, the output control unit 103 issues alarm. The device used for the alarm is not particularly limited, and examples thereof include a terminal device, a lighting device, and a voice output device. A specific alarm example will be described in detail with reference to a second example embodiment.

### (Flowchart)

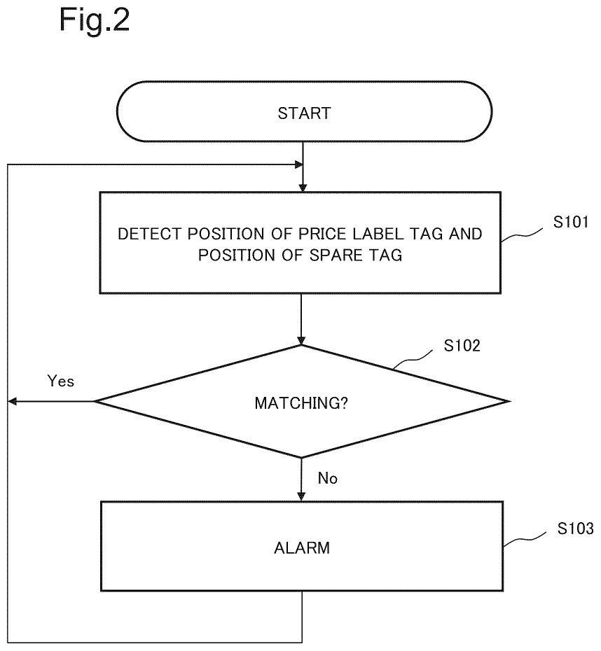

FIG. 2 is a flowchart illustrating an operation example of an alarm system 10 according to the first example embodiment. The position detection unit 101 detects the position of the price label tag and the position of the spare tag (step S101). Next, the determination unit 102 determines whether the position of the price label tag matches the position of the spare tag (step S102). In a case where both the positions match each other (step S102: Yes), the alarm system 10 returns to step S101. If those positions do not match (step S102: No), the output control unit 103 issues alarm (step S103), and the alarm system 10 returns to step S101.

In a case where the alarm is performed, the alarm system 10 may end the processing. Alternatively, the flowchart may be appropriately ended.

For example, an RFID tag included in a price label tag is provided with tag identification information for identifying the tag. For example, whether checkout has been completed is managed by accounting information such as an accounting flag associated with tag identification information for identifying a tag. The price label tag is attached to the product, for example by means of a string or the like. A reading device capable of reading the RFID tag is provided at a gate or the like of an entrance of a store, and a customer carries a product and passes through the gate. For example, there is a mechanism in which tag identification information is read from the price label tag, and an alert is sounded in a case where an accounting flag associated with the tag identification information indicates that checkout has not been performed. Such a mechanism is generally known. For this reason, in a case where a customer shoplifts a product, the customer may remove a price label tag from the product in the store and take the product home. That is, some customers think that if the price label tag is removed from the product, even if shoplifting is performed, it will not be revealed to the clerk.

Therefore, in the first example embodiment, the alarm system 10 issues alarm in a case where the position of the price label tag attached to the product does not match the position of the spare tag attached to the product. This makes it possible to give notification that the price label tag may have been removed. Therefore, shoplifting can be suppressed.

Monitoring whether the price label tag is removed from the product for all the customers from the image captured by the image capturing device is a heavy processing load. It is difficult to detect whether the price label tag has been removed from the product depending on the image accuracy captured by the image capturing device. According to the alarm system 10 according to the first example embodiment, the processing load can be made lower than that in a case where an image is constantly monitored. It is possible to suppress shoplifting with a simpler configuration than that of constantly monitoring an image.

If the customer visits the store together with the shoplifted product, the accounting information about the price label tag of the product remains the information indicating that checkout is not performed. Therefore, the alarm system 10 can determine that the position of the spare tag of the product does not match the position of the price label tag, and perform the alarm again. Therefore, the customer who has shoplifted can be easily identified.

### Second Example Embodiment

Next, a second example embodiment will be described in detail with reference to the drawings. In the second example embodiment, an alarm example and an example of an alarm destination will be described in detail. Hereinafter, description of content overlapping with the above description will be omitted to the extent that the description of the second example embodiment is not unclear.

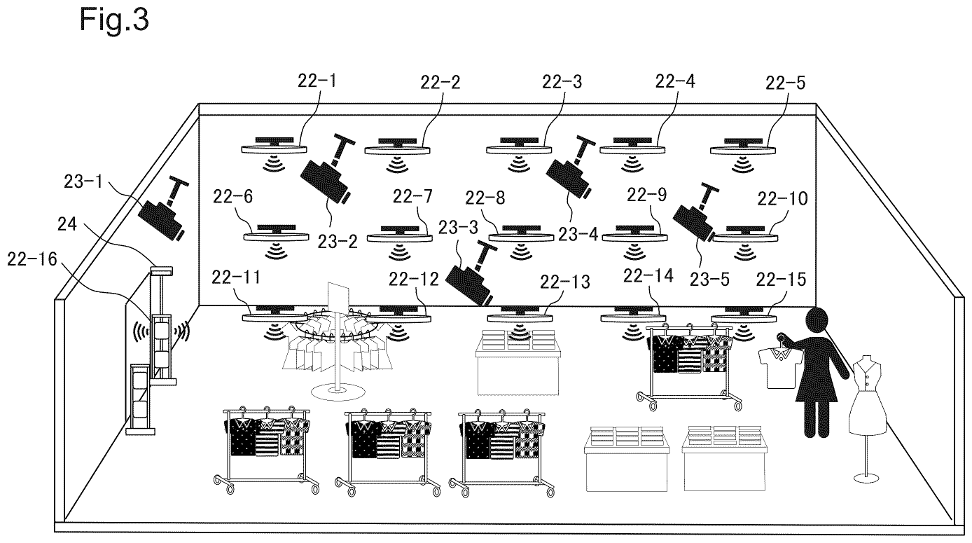

FIG. 3 is an explanatory diagram illustrating an installation example of a plurality of reading devices and a plurality of image capturing devices in a store. The plurality of reading devices 22 are installed at different positions. For example, in FIG. 3, a plurality of reading devices 22-1 to 22-15 is installed on a ceiling. For example, in FIG. 3, a reading device 22-16 is installed at a gate at an entrance of the store.

The plurality of reading devices 22 is reading devices 22 capable of reading information stored in a first RFID tag included in a price label tag and information stored in a second RFID tag included in a spare tag.

The plurality of reading devices 22 can output, for example, received signal strength. The received signal strength is used to identify the position of each tag. The number of reading devices 22 is 16 in the example, but the number of reading devices 22 is not particularly limited. The reading device 22 is referred to as a reading device 22 unless otherwise specified.

For example, in FIG. 3, a voice output device 24 capable of outputting an alert may be installed at the gate of the entrance of the store. The type of the output device installed at the gate of the entrance of the store is not particularly limited.

In FIG. 3, a plurality of image capturing devices 23-1 to 23-5 captures an image of a person in the store. The person is a customer or a clerk. The alarm system may detect the action of the person by the images captured by the plurality of image capturing devices 23. For example, the alarm system may detect a flow line of the person. The number of image capturing devices 23 is not particularly limited.

Although an example in which the number of the image capturing devices 23 is five is described, the number of the image capturing devices 23 is not particularly limited. In a case where the image capturing device 23 is not particularly limited, it is referred to as an image capturing device 23.

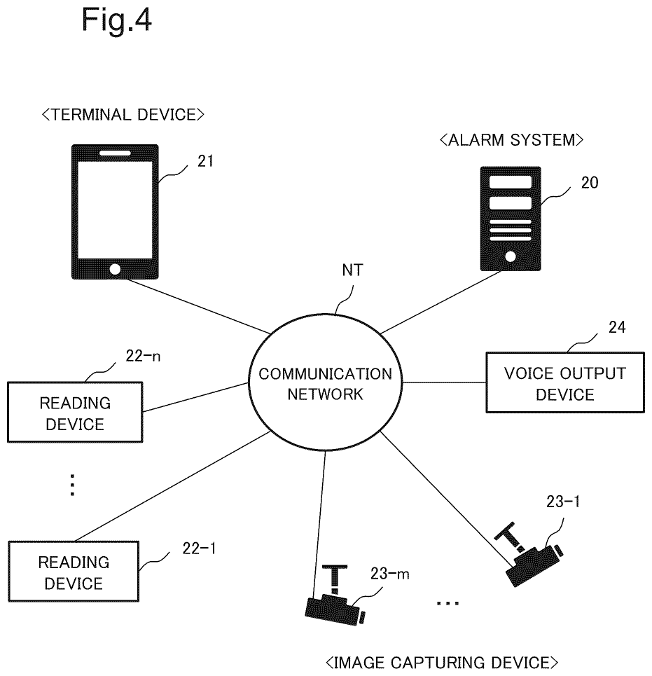

FIG. 4 is an explanatory diagram illustrating an example of connection between the alarm system and another device. For example, the alarm system 20 is connected to the plurality of reading devices 22 via a communication network NT. For example, the alarm system 20 is connected to the plurality of image capturing devices 23 via the communication network NT. For example, the alarm system 20 is connected to the voice output device 24 via the communication network NT.

For example, the alarm system 20 is connected to the terminal device 21 via the communication network NT. The number of terminal devices 21 is not particularly limited. The terminal device 21 may be the terminal device 21 of the clerk, the terminal device 21 of the customer, or the terminal device 21 installed in the store. In FIG. 4, the type of the terminal device 21 is not particularly limited, and examples thereof include a personal computer (PC), a smartphone, a tablet-type device, and a signage. In the terminal device 21, an application program capable of outputting alarm and notice from the alarm system 20 may be installed in advance.

Furthermore, the alarm system 20 may be connected to a point of sales (POS) server or the like via the communication network NT.

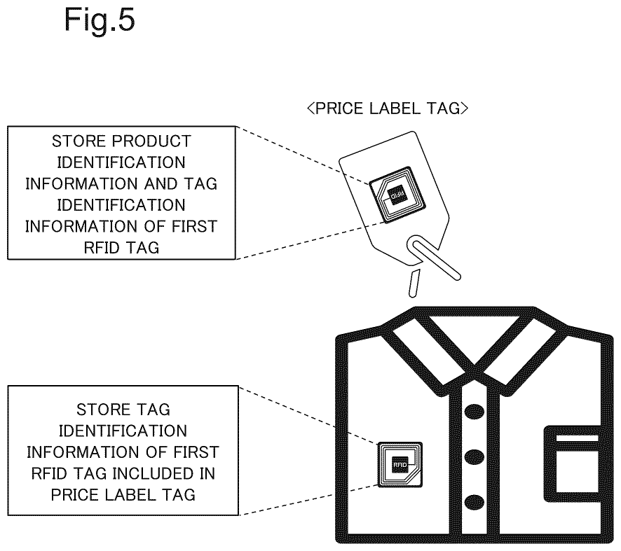

FIG. 5 is an explanatory diagram illustrating a storage example of the first RFID tag and the second RFID tag. The first RFID tag is included in the price label tag. In the price label tag, the size of the product, the price of the product, and the like are described. For example, the first RFID tag is included between papers of the price label tag. The first RFID tag stores, for example, product identification information for identifying a product. The product identification information is not particularly limited as long as the product identification information can identify the product.

On the other hand, the second RFID tag is included in the spare tag. The spare tag may be, for example, a button, a laundry tag, or a paper tag different from the price label tag. For example, the spare tag may be a non-removable tag or a removable tag. Here, the term “not removable” refers to a state in which a customer cannot easily remove the spare tag by hand or the like. For example, it may be assumed that in a case where a customer actually uses a product after purchasing the product, the price label tag is removed and the product is used, but the spare tag is not removed and the product is used.

The first RFID tag included in the price label tag may store product identification information identifying a product and tag identification information identifying the first RFID tag. The product identification information is not particularly limited as long as the product identification information can identify the product. The tag identification information is not particularly limited as long as the tag identification information can identify the RFID tag.

The second RFID tag included in the spare tag stores tag identification information for identifying the first RFID tag.

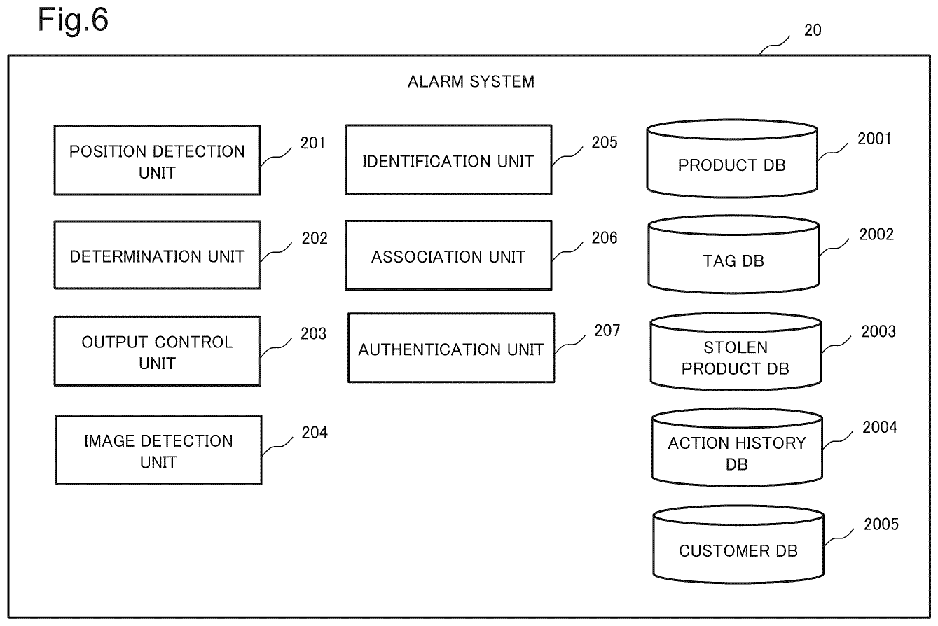

FIG. 6 is a block diagram illustrating a configuration example of the alarm system 20 according to the second example embodiment. The alarm system 20 includes, for example, a position detection unit 201, a determination unit 202, an output control unit 203, an image detection unit 204, an identification unit 205, and an association unit 206. The alarm system 20 is different from the alarm system 10 according to the first example embodiment in that an image detection unit 204, an identification unit 205, and an association unit 206 are added.

The position detection unit 201 has the function of the position detection unit 101 according to the first example embodiment as a basic function. The determination unit 202 has the function of the determination unit 102 according to the first example embodiment as a basic function. The output control unit 203 has the function of the output control unit 103 according to the first example embodiment as a basic function.

The alarm system 20 includes, for example, a product database (DB) 2001, a tag DB 2002, a stolen product DB 2003, an action history DB 2004, and a customer DB 2005.

The product DB 2001 stores, for example, product information for each product. For example, the product DB 2001 stores product identification information and product information in association with each other. The product information is information such as a name of a product, a price of the product, an image of the product, and a size of the product.

The tag DB 2002 stores accounting information indicating whether the price label tag has been accounted for. For example, the tag DB 2002 stores tag identification information for identifying a price label tag and accounting information in association with each other. The accounting information is, for example, information indicating whether a product to which a price label tag including an RFID tag identified by tag identification information is attached has been checked out. In the tag DB 2002, information indicating no checkout is set as the accounting information before the checkout of the product, and in a case where the checkout of the product is performed, the information is changed to information indicating that checkout has been performed as the accounting information.

The stolen product DB 2003 stores, for example, tag identification information for identifying a first RFID tag included in a price label tag when the position of the price label tag and the position of the spare tag do not match. Further, for example, the stolen product DB 2003 may store the tag identification information and the information on the date and time when the mismatch is determined in association with each other.

The action history DB 2004 stores an action history of a person such as a customer or a clerk. The action history DB 2004 stores person identification information for identifying a person and an action history in association with each other. In a case where the person is a customer, the person identification information is customer identification information for identifying the customer, and in a case where the person is a clerk, the person identification information is clerk identification information for identifying the clerk.

The customer DB 2005 stores biological information for each customer. For example, the biometric information is used to authenticate the customer. The type of authentication is not particularly limited. In the second example embodiment, in order to describe the face authentication as an example, the biometric information is, for example, information regarding a feature of a face. Specifically, the customer DB 2005 stores customer identification information for identifying a customer and biological information in association with each other.

The customer DB 2005 may store, for each customer, customer terminal device identification information for identifying the terminal device 21 of the customer. For example, the customer terminal device identification information is, for example, information about the terminal device 21 necessary for issuing an alarm to the terminal device 21 of the customer. For example, an application program capable of performing alarm may be installed in the terminal device 21 of the customer. The customer identification information and the customer terminal device identification information may be the same. The customer terminal device identification information may be a contact address of the customer, such as an address of an email, a destination of an electronic message, or the like.

Next, each function unit will be described.

The position detection unit 201 detects the position of the price label tag and the position of the spare tag by the reading device 22 installed in the store. The position detection unit 201 can detect the position of the RFID tag in the store based on the received signal strength output from the plurality of reading devices 22. The stronger the received signal strength for the signal of the RFID tag received by the reading device 22, the closer the RFID tag is to the reading device 22. For example, as a method for detecting a more detailed position, the position detection unit 201 may detect the position of the RFID tag by performing three-point positioning based on the received signal strength in the plurality of reading devices 22. In this manner, the position detection unit 201 may detect the position of each tag using an existing technology.

The determination unit 202 determines whether the position of the price label tag matches the position of the spare tag. Here, the price label tag to be determined is a tag indicating that the accounting information included in the tag DB 2002 is unchecked out. The determination may not be made for the product that has been checked out. Therefore, the price label tag indicating that the accounting information included in the tag DB 2002 has been checked out is not to be determined.

In a case where the second RFID tag stores tag identification information for identifying the first RFID tag, the determination unit 202 determines whether the position of the spare tag matches the position of the price label tag including the first RFID tag identified by the tag identification information stored in the second RFID tag included in the spare tag.

Then, the output control unit 203 issues alarm in a case where the position of the price label tag does not match the position of the spare tag. The type of the device used for the alarm is not particularly limited, and examples thereof include a terminal device, a display device, a voice output device, a lighting device, and a combination thereof. The output control unit 203 may issue alarm to the clerk or the customer.

Here, the output control unit 203 may issue alarm immediately after it is determined that the position of the price label tag does not match the position of the spare tag. For example, if a product is not taken out from a store without payment, shoplifting does not occur. Therefore, the output control unit 203 may issue alarm at the timing when the customer leaves the gate of the entrance of the store. As described above, the timing at which the alarm is performed is not particularly limited.

On the other hand, the output control unit 203 does not issue alarm in a case where the position of the price label tag matches the position of the spare tag. Alternatively, the output control unit 203 may output that there is no problem in a case where the position of the price label tag matches the position of the spare tag.

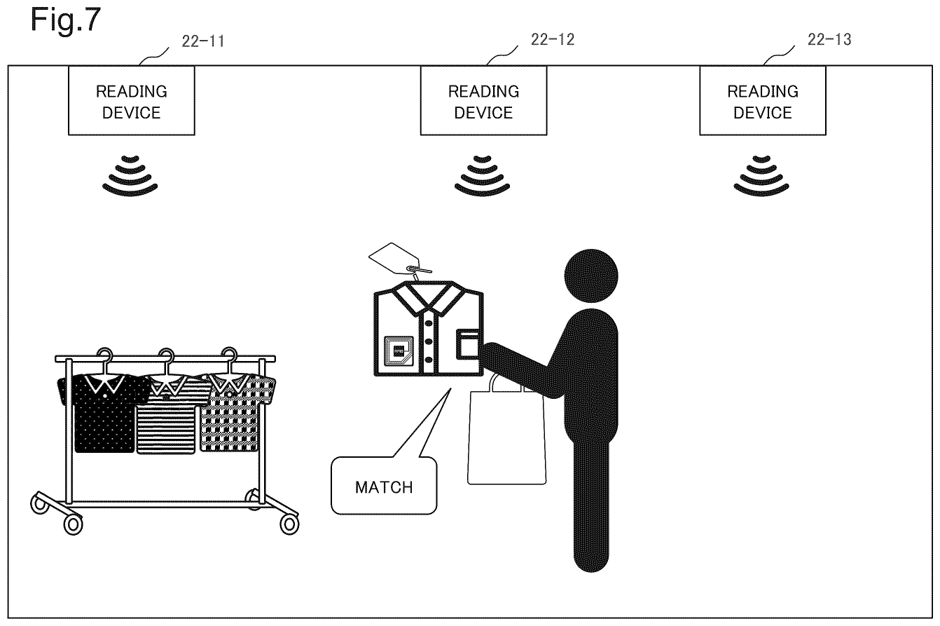

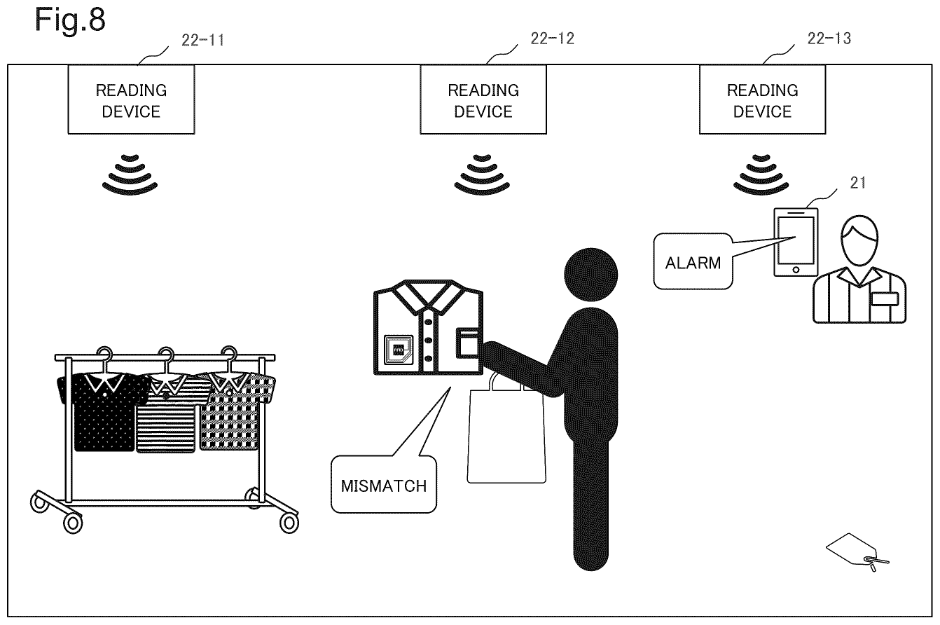

Here, an example of alarm and an example of non-alarm will be briefly described with reference to FIGS. 7 and 8.

FIG. 7 is an explanatory diagram showing an example in which the position of a price label tag and the position of a spare tag match. In FIG. 7, a price label tag and a spare tag are attached to a product. Here, the position of the reading device 22 will be described as an example of the position of each tag. The position detection unit 201 detects the position of the reading device 22-12 as the position of the price label tag of the product. The position detection unit 201 detects the position of reading device 22-12 as the position of the spare tag. Since the positions of the price label tag and the spare tag of the product are both the positions of the reading device 22-12, the determination unit 202 determines that the price label tag of the product and the spare tag match. Then, since the position of the price label tag and the position of the spare tag match each other, the output control unit 203 does not issue alarm.

FIG. 8 is an explanatory diagram showing an example in which the position of the price label tag and the position of the spare tag do not match. In FIG. 8, the product are fitted with a spare tag, but the price label tag is removed. Here, the position of the reading device 22 will be described as an example of the position of each tag. The position detection unit 201 detects the position of the reading device 22-13 as the position of the price label tag of the product. The position detection unit 201 detects the position of reading device 22-12 as the position of the spare tag. Since the position of the price label tag of the product is the reading device 22-13, but the position of the spare tag is the position of the reading device 22-12, the determination unit 202 determines that the price label tag of the product does not match the spare tag. Then, since the position of the price label tag does not match the position of the spare tag, the output control unit 203 issues alarm. In FIG. 8, the output control unit 203 issues alarm to the terminal device 21 of the clerk.

### <Example in Which Alarm is Issued to Terminal Device 21 Installed In Store>

For example, the output control unit 203 outputs alarm to the terminal device 21 installed in the store. As a result, an alarm is issued to at least one of the clerk and the customer. For example, the terminal device 21 installed in the store may be the terminal device 21 of the store near the position of the spare tag. The alarm system 20 stores in advance information on the position of the terminal device 21 installed in the store, in the store. The terminal device 21 of the store near the position of the spare tag may be determined based on whether the terminal device 21 is at a distance from the spare tag within a predetermined distance. For example, the output control unit 203 issues alarm to the terminal device 21 of the store closest to the position of the detected spare tag. Since the spare tag is attached to the product, the terminal device 21 of the store closest to the position of the spare tag is in the vicinity of the customer carrying the product from which the price label tag has been removed. Therefore, there is a high possibility that an alarm is issued to the customer holding the product from which the price label tag has been removed.

Similarly to the spare tag, for example, the output control unit 203 may output an alarm to the terminal device 21 of the store near the position of the price label tag. The terminal device 21 of the store in the vicinity of the position of the price label tag may be determined by whether it is a terminal device 21 whose distance from the price label tag is within a predetermined distance. For example, a clerk near a price label tag can find the price label tag. More specifically, for example, the output control unit 203 may output an alarm to the terminal device 21 of the store closest to the position of the price label tag.

The output control unit 203 may issue alarm to the terminal device 21 in the vicinity of the display position of the product to which the price label tag is attached. Specifically, for example, the output control unit 203 issues alarm to the terminal device 21 in the vicinity of the product display position based on the product display position information associated with the product identification information included in the price label tag in the product DB 2001. The terminal device 21 in the vicinity of the product display position may be determined based on whether the terminal device 21 has a distance from the display position within a predetermined distance. More specifically, for example, the output control unit 203 may output the alarm to the terminal device 21 of the store closest to the display position of the product to which the price label tag is attached.

### <Example of Alarm to Terminal Device 21 Near Customer>

For example, an example in which an alarm is issued to the terminal device 21 near the customer will be described. The output control unit 203 may issue alarm to the terminal device 21 near the customer holding the product.

Specifically, for example, the image detection unit 204 detects a series of images before and after the time at which the mismatch is determined from the image captured by the image capturing device 23 installed in the store. Here, the series of preceding and following images is a series of images from a time that is a first predetermined time or more before the time at which the mismatch is determined to a time that is a second predetermined time after the time at which the mismatch is determined. The image detection unit 204 may detect a series of images from a time that is the first predetermined time or more before the time at which the mismatch is determined from the image to a time at which the mismatch is determined.

Then, the identification unit 205 identifies the customer having the product to which the spare tag is attached from the detected series of images. The identification unit 205 may identify the position of the customer in the store together with the customer from a series of images. The output control unit 203 issues alarm to the terminal device 21 in the vicinity of the identified customer. Whether the terminal device 21 is in the vicinity of the customer may be determined based on whether the distance from the position of the customer is within a predetermined distance.

The reading device 22 may be installed in the terminal device 21 installed in the store, and the position detection unit 201 may detect the position of the price label tag and the position of the spare tag using the reading device 22 installed in the terminal device 21. The determination unit 202 then determines a match between the position of the price label tag and the position of the spare tag. Then, in a case where the mismatch is determined, the output control unit 203 issues alarm to the terminal device 21. For example, the output control unit 203 may issue alarm to call the clerk. A display may be made in such a way that the clerk can identify the determination that the clerk that the position of the price label tag and the position of the spare tag are mismatched. For example, the called clerk can easily confirm that the customer has the product from which the price label tag has been removed by confirming a screen of the terminal device 21.

### <Example of Issuing Alarm to Terminal Device 21 That Has Authenticated the Customer>

For example, the output control unit 203 may issue alarm to the terminal device 21 that has authenticated the customer.

Furthermore, for example, the image detection unit 204 detects a series of images before and after the time at which the mismatch is determined from the image captured by the image capturing device 23 installed in the store. The identification unit 205 identifies the customer having the product to which the spare tag is attached from the series of detected images.

On the other hand, the authentication unit 207 may authenticate the customer via the terminal device 21 installed in the store, for example. The authentication unit 207 authenticates the customer by comparing information regarding the feature of the face obtained from the image of the customer captured by the image capturing device 23 provided in the terminal device 21 installed in the store with information regarding the feature of the face stored in the customer DB 2005. For example, in a case where the authenticated customer is the customer identified by the identification unit 205, the output control unit 203 issues alarm to the terminal device 21 of the customer. For example, the output control unit 203 may make a pop-up alarm to the terminal device 21 of the customer.

For example, the authentication unit 207 may authenticate the customer via a mirror provided with the image capturing device 23. Specifically, for example, the authentication unit 207 authenticates the customer by comparing information regarding the feature of the face obtained from the image of the customer captured by the image capturing device 23 provided in the mirror with information regarding the feature of the face stored in the customer DB 2005. Then, for example, in a case where the authenticated customer is the customer identified by the identification unit 205, the output control unit 203 issues alarm to the terminal device 21 of the identified customer.

For example, in the case of making an alarm to the terminal device 21 of the customer, the output control unit 203 may notify the terminal device 21 of the customer of a product including the spare tag for which mismatch is determined as a recommended product. For example, the output control unit 203 notifies the terminal device 21 of the customer of a product including the spare tag for which the mismatch is determined as a forgotten product. As a result, the store side can indicate to the customer that the store side has grasped the behavior of the customer.

### <Example of Issuing Alarm at Gate of Entrance of Store>

The position detection unit 201 detects the position of the price label tag and the position of the spare tag by means of a reading device 22 installed at the gate, and the determination unit 202 determines whether the position of the price label tag matches the position of the spare tag. Then, when the mismatch is determined, the output control unit 203 issues alarm to the output device installed at the gate. As the output device, the voice output device 24 is exemplified in FIG. 3.

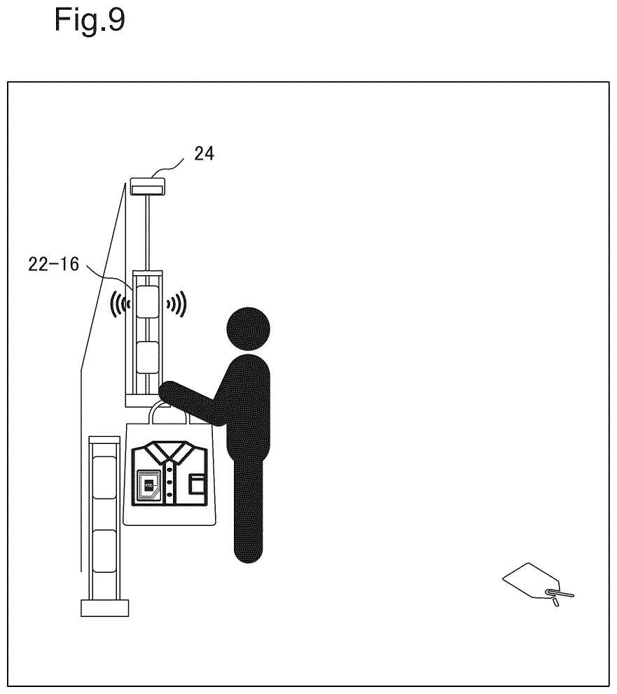

FIG. 9 is an explanatory diagram illustrating an example of issuing alarm at a gate of an entrance. In FIG. 9, a customer is about to pass through a gate of an entrance installed in a store. For example, the position detection unit 201 detects the position of the price label tag and the position of the spare tag via the reading device 22 installed at the entrance of the store. In FIG. 9, since the price label tag has been removed from the product, the received signal strength of the signal from the price label tag in the reading device 22 is weak and the received signal strength of the signal from the spare tag is strong. Thus, the determination unit 202 determines that the price label tag of the product does not match the spare tag. Then, since the position of the price label tag does not match the position of the spare tag, the output control unit 203 issues alarm to the voice output device 24 provided at the gate of the entrance. For example, the output control unit 203 may cause the voice output device 24 to output a beep sound. Alternatively, for example, the output control unit 203 may cause the voice output device 24 to output a voice such as “Are there any unchecked products?”.

For example, the alarm may be performed when a mismatch is determined at another place in the store other than the gate provided at the entrance of the store and the customer tries to leave the gate.

For example, the image detection unit 204 detects a series of images before and after the time when the mismatch is determined from the image captured by the image capturing device 23 installed in the store. The identification unit 205 identifies the customer having the product to which the spare tag is attached from the series of detected images. Then, the image detection unit 204 tracks the identified customer from the image captured by the image capturing device 23 installed in the store.

The output control unit 203 issues alarm to the output device installed at the gate when the identified customer passes through the gate installed at the entrance. As described above, if the user leaves the store with the unpaid product, the user is treated as shoplifting. Therefore, an alarm can be issued when the user leaves the gate.

### <Example of Issuing Alarm in Product Registration Device>

Similarly to the example of issuing alarm at the gate of the entrance of the store referring to FIG. 9, for example, the position detection unit 201 detects the position of the price label tag and the position of the spare tag by the reading device 22 installed in the product registration device. The determination unit 202 may then determine a match between the position of the price label tag and the position of the spare tag. Then, the output control unit 203 may issue alarm to the product registration device in a case where it is determined that there is a mismatch. The product registration device may be a self-type POS terminal device operated by a customer, or may be a POS terminal device operated by a clerk. For example, in the case of the self-type terminal device 21, the output control unit 203 may issue alarm for calling the clerk when mismatch is detected.

For example, the alarm may be performed when a mismatch is determined at another place in the store other than the product registration device and the customer performs product registration with the product registration device. Specifically, for example, the image detection unit 204 detects a series of images before and after the time at which the mismatch is determined from the image captured by the image capturing device 23 installed in the store. The identification unit 205 identifies the customer having the product to which the spare tag is attached from the series of detected images. Then, the image detection unit 204 tracks the identified customer from the image captured by the image capturing device 23 installed in the store. When the registration of the product to be purchased by the customer identified in the product registration device is started, the output control unit 203 issues alarm to the product registration device.

The alarm may be issued by the checkout device instead of the product registration device. The product registration device may have a function of a checkout device.

### <Application Example of Issuing Alarm to Terminal Device 21 of Clerk>

For example, the output control unit 203 outputs an alarm to the terminal device 21 of the clerk. This allows the clerk to be notified immediately.

More specifically, for example, in a case where the position of the clerk can be detected, the output control unit 203 outputs alarm to the terminal device 21 of the clerk based on the position of the spare tag and the position of the clerk. The position of the terminal device 21 of the clerk may be used as the position of the clerk. As a method of detecting the position of the clerk, an existing technique such as detection of the position by a beacon or an RFID tag using the terminal device 21 of the clerk, or position detection from an image captured by the image capturing device 23 may be used. For example, the output control unit 203 outputs alarm to the terminal device 21 of the clerk near the position of the spare tag. Whether the tag is near the spare tag may be determined based on whether the distance from the spare tag is within a predetermined distance. The output control unit 203 may notify the terminal device 21 of the clerk closest to the position of the spare tag.

Alternatively, similarly to the spare tag, for example, in a case where the position of the clerk can be detected, the output control unit 203 outputs alarm to the terminal device 21 of the clerk based on the position of the price label tag and the position of the clerk. For example, the output control unit 203 outputs alarm to the terminal device 21 of the clerk in the vicinity of the position of the price label tag. The proximity of the price label tag may be determined by whether the distance from the price label tag is within a predetermined distance. The output control unit 203 may issue alarm to the terminal device 21 of the clerk who is closest to the position of the price label tag.

The output control unit 203 may display at least one of the position of the spare tag in which the mismatch is detected and the position of the price label tag on the map of the store.

Here, in a case where the alarm is made to the terminal device 21 of the clerk, the alarm may be made so that the clerk can easily take measures against shoplifting.

The image detection unit 204 detects a series of images before and after the time at which the mismatch is determined from the image captured by image capturing device 23 installed in the store. The image here is a time-series image group. The series of images to be detected are time-series images.

The output control unit 203 may display the time-series images on the terminal device 21 of the clerk.

For example, the association unit 206 stores the time at which mismatch is determined and the series of images detected by the image detection unit 204 in the database in association with each other. The time when the mismatch is determined may be a date and time when the mismatch is determined in more detail. In a case where a plurality of image capturing devices 23 is installed in a store, the image detection unit 204 may detect a series of images before and after the time when the mismatch is determined from the image captured by the image capturing device 23 installed in the vicinity of the position of the spare tag among the plurality of image capturing devices 23 installed in the store. Alternatively, the image detection unit 204 may detect a series of images before and after the time at which the mismatch is determined from the image captured by the image capturing device 23 installed in the vicinity of the position of the price label tag among the image capturing devices 23 installed in the store. A customer may remove the price label tag and then hide it in a bag. Therefore, it is possible to immediately hold evidence of shoplifting by cooperating with the image.

Then, the output control unit 203 may display, on the terminal device 21 of the clerk, the time when the mismatch is determined and the series of images detected by the image detection unit 204 in association with each other.

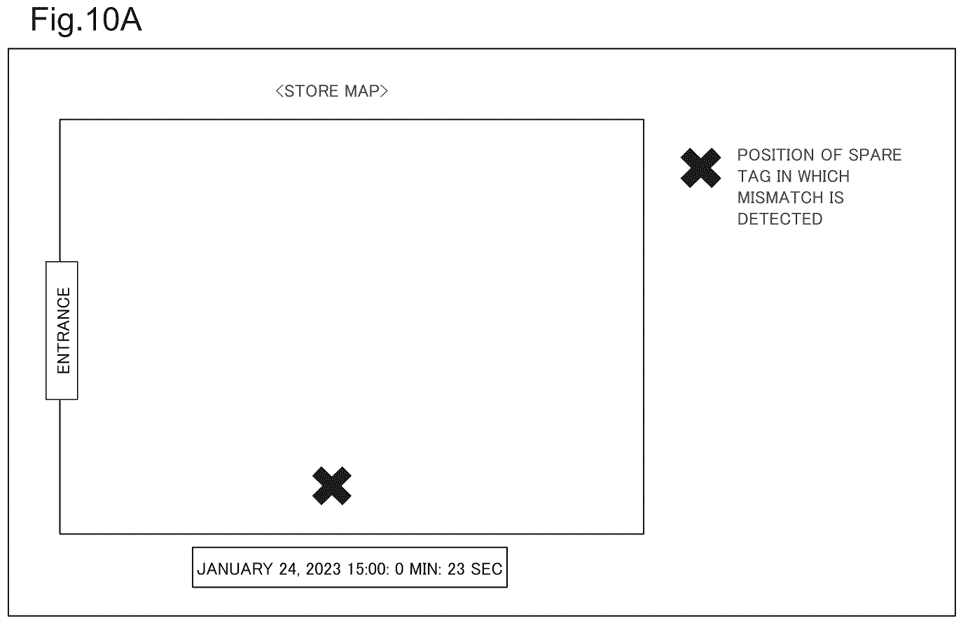

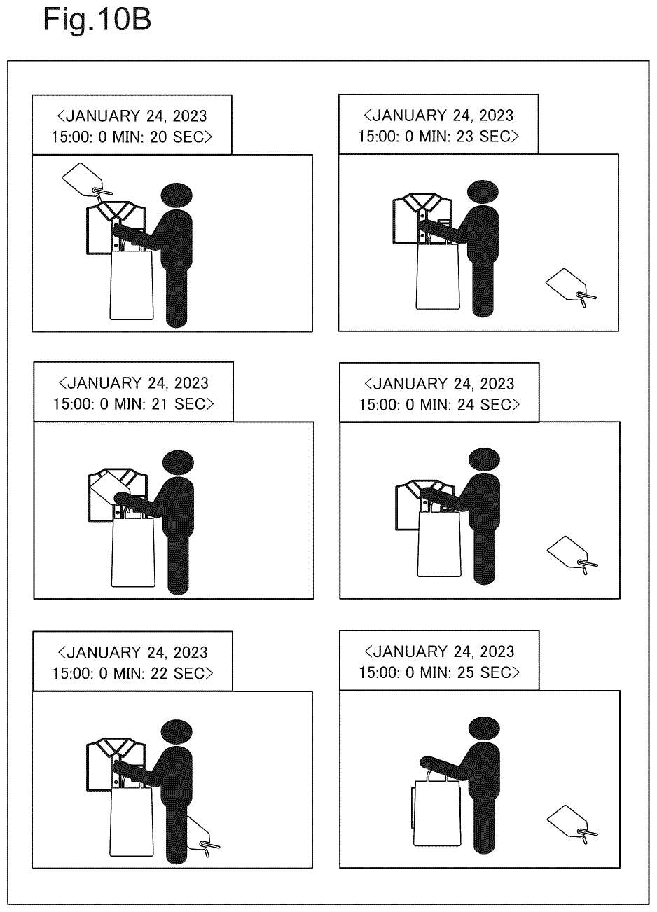

FIGS. 10A and 10B are explanatory diagrams illustrating an example of issuing an alarm to the terminal device 21 of the clerk. In FIG. 10A, the output control unit 203 displays, on the terminal device 21 of the clerk, the position of the spare tag for which mismatch is determined on the map of the store. Then, in FIG. 10B, when the position of the spare tag for which mismatch is determined is tapped, the output control unit 203 may display, on the terminal device 21 of the clerk, a series of detected images. In FIG. 10, the screen of the terminal device 21 of the clerk displays each of the series of images in association with the captured time.

In the case that the traffic line is displayed on the terminal device 21 of the clerk, the traffic line of the customer holding the product including the spare tag of which the mismatch is determined may be identifiably displayed.

For example, the image detection unit 204 detects a series of images before and after the time when the mismatch is determined from the captured image. Then, the identification unit 205 identifies the customer having the product to which the spare tag is attached from the detected series of images. The output control unit 203 displays, on the terminal device 21 of the clerk, the traffic line of the identified customer in such a way as to be able to identify that mismatch is determined.

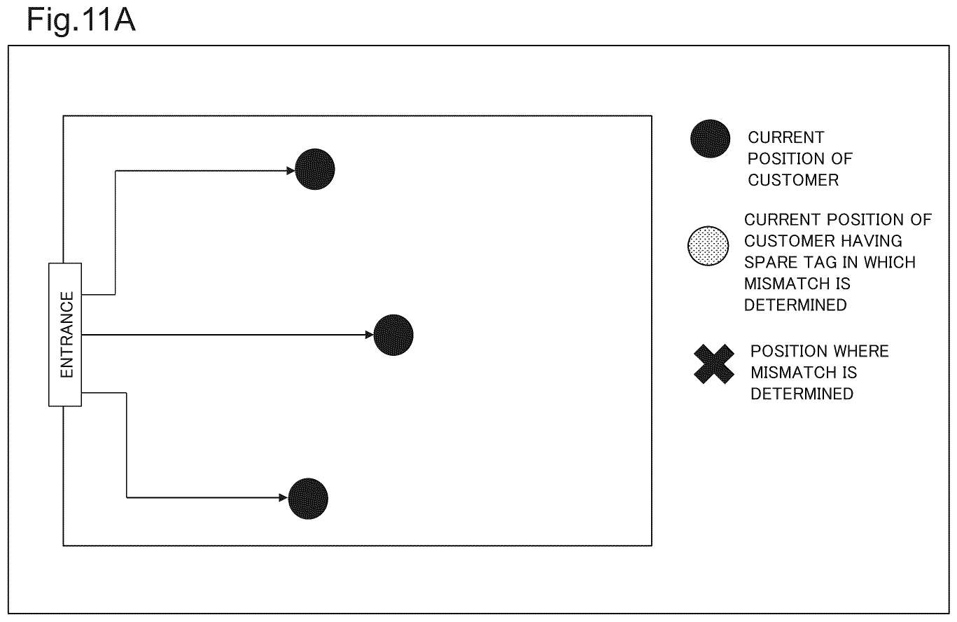

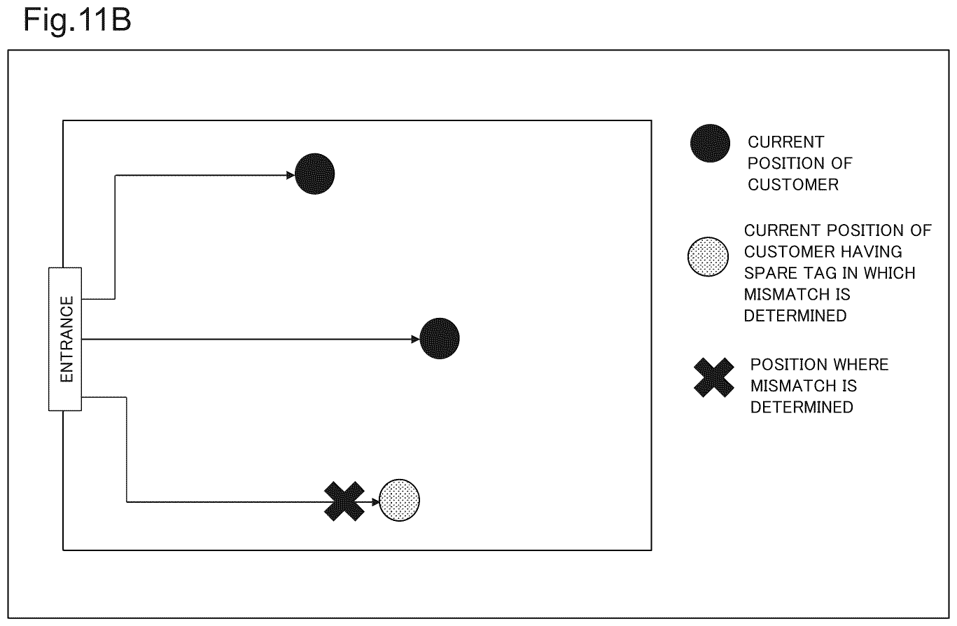

FIGS. 11A and 11B are explanatory diagrams illustrating examples of displaying traffic lines of customers. In FIG. 11A, the output control unit 203 displays, on the terminal device 21 of the clerk, the traffic line for each of the plurality of customers.

In FIG. 11A, traffic lines of three customers are displayed on the screen of the terminal device 21. In FIG. 11B, when it is determined that the position of the spare tag of the product held by a certain customer and the position of the price label tag do not match, the output control unit 203 displays the position where the mismatch is determined and the current position of the customer having the spare tag of the product where the mismatch is determined and the current position of another customer in an identifiable manner. As a result, the clerk can confirm the customer holding the product from which the price label tag has been removed while confirming the traffic line of each customer.

The above-described alarm methods and alarm destinations may be used in appropriate combination.

The determination unit 202 stores tag identification information for identifying the price label tag for which mismatch is determined in the stolen product DB 2003. More specifically, the determination unit 202 may cause the stolen product DB 2003 to store the date and time when the mismatch is determined and tag identification information for identifying the price label tag for which the mismatch is determined in association with each other. For example, in a case where the mismatch is determined since the position of the spare tags is not detected in the store, the determination unit 202 may store the date and time when the mismatch is determined and tag identification information for identifying the price label tag for which the mismatch is determined in association with each other in the stolen product DB 2003.

As described above, if the customer visits the store together with the shoplifted product, the accounting information of the price label tag of the product remains the information indicating that checkout is not performed. The position detection unit 201 detects the position of the spare tag attached to the product and the position of the price label tag identified by the tag identification information stored in the second RFID included in the spare tag. In a case where the product is a shoplifted product, the determination unit 202 determines that the position of the spare tag does not match the position of the price label tag. In a case where mismatch is determined, if the tag identification information of the price label tag stored in the second RFID tag included in the spare tag is registered in the stolen product DB 2003 and the date and time stored in association with the tag identification information is different, the output control unit 203 gives a notification that the customer visits the store together with the stolen product. For example, the output control unit 203 notifies the terminal device of the clerk that the customer visits the store together with the stolen product. As a result, the clerk can confirm a customer who has shoplifted in the store in the past. The stolen flabs and the like may be stored in association with the tag identification information of the price label tag. Then, the output control unit 203 may determine whether the product is the stolen product based on the presence or absence of the theft flag associated with the tag identification information of the price label tag stored in the second RFID tag included in the spare tag attached to the product. Then, the output control unit 203 may issue alarm in a case where the product is a stolen product.

When detecting the traffic line of the customer from each image, the image detection unit 204 stores the traffic line of the customer in action history DB 2004.

### (Flowchart)

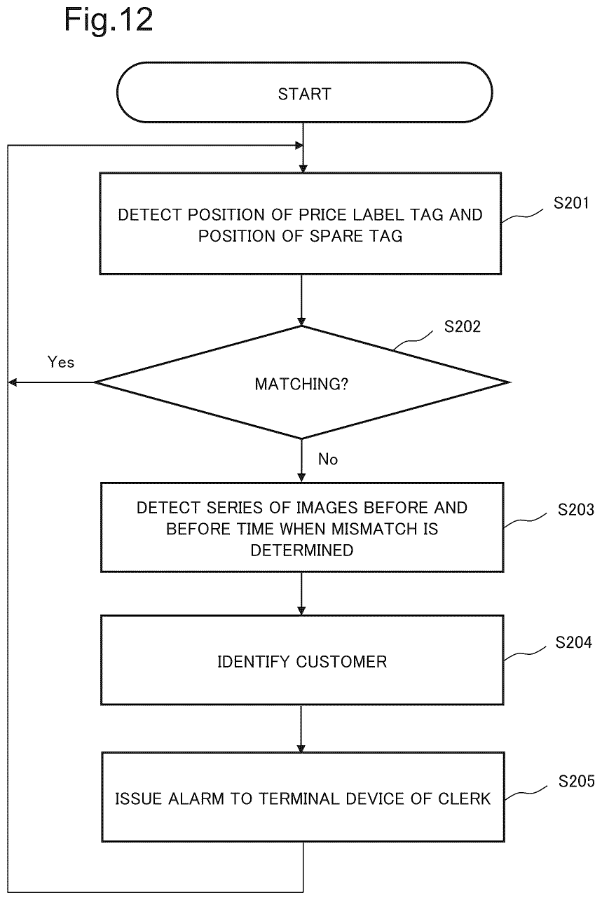

FIG. 12 is a flowchart illustrating an operation example of the alarm system 20 according to the second example embodiment. Here, a flowchart in a case where the traffic line of the customer is displayed on the terminal device 21 of the clerk in FIG. 12 will be described.

The position detection unit 201 detects the position of the price label tag and the position of the spare tag (step S201). The determination unit 202 determines whether the position of the price label tag matches the position of the spare tag (step S202). If the position of the price label tag matches the position of the spare tag (step S202: Yes), the alarm system 20 returns to step S201.

On the other hand, in a case where the position of the price label tag does not match the position of the spare tag (step S202: No), the image detection unit 204 detects a series of images before and after the time at which the mismatch is determined from the image captured by the image capturing device 23 installed in the store (step S203). Here, the association unit 206 stores the time when the mismatch is determined and the detected series of images in the database in association with each other.

The identification unit 205 specifies the customer having the product to which the spare tag is attached from the series of detected images (step S204). Then, the output control means displays, on the terminal device 21 of the clerk, the traffic line of the identified customer in such a way as to be able to identify that mismatch is determined (step S205), and the alarm system 20 returns to step S201. The flowchart may be appropriately ended. The start timing of the flowchart is not particularly limited. For example, the operation may be performed at all times, or the operation may be started at any timing according to an instruction from a clerk.

As described above, in the second example embodiment, the second RFID tag stores tag identification information for identifying the first RFID tag, and the alarm system 20 determines whether the position of the spare tag matches the position of the price label tag including the first RFID tag identified by the tag identification information stored in the second RFID tag included in the spare tag. This associates a price label tag of a product with a spare tag of the product in a case where there are a plurality of products.

The alarm system 20 issues alarm to at least one of the terminal device 21 of the clerk, the terminal device 21 of the store near the spare tag, the terminal device 21 of the store near the price label tag, and the terminal device 21 near the display position of the product to which the price label tag is attached.

The alarm system 20 issues alarm to the product registration device that performs product registration by the operation of the customer. Furthermore, in a case where alarm is issued to the product registration device, the alarm system 20 calls the clerk.

The reading device 22 is provided in a terminal device 21 installed in a store and operable by a customer. In a case where mismatch is made, the alarm system 20 issues alarm to the terminal device 21. This makes it possible to notify the customer of the product from which the price label tag has been removed.

The alarm system 20 detects a series of images before and after the time when the mismatch is determined from the image captured by the image capturing device 23 installed in the store, and identifies the customer having the product to which the spare tag is attached from the series of detected images. Then, the alarm system 20 issues alarm to at least one of the terminal device 21 near the identified customer, the terminal device 21 of the identified customer, and the terminal device 21 that has authenticated the identified customer.

If the user does not leave the store with an unpaid product, shoplifting does not occur. Therefore, the alarm system 20 may issue alarm to an output device installed at the entrance of the store when the customer leaves the store. The reading device 22 is installed at an entrance of a store.

A customer may hide a product in a bag after removing the price label tag. Therefore, in a case where the images do not match, the alarm system 20 detects a series of images before and after the time at which the mismatch is determined from the image captured by the image capturing device 23 installed in the store, and stores the time at which the mismatch is determined and the detected series of images in the database in association with each other. As a result, evidence of shoplifting in the image can be immediately stored. The alarm system 20 displays, on the terminal device 21 of the clerk, the time when the mismatch is determined and the series of detected images in association with each other. As a result, evidence of shoplifting can be presented to the clerk.

The alarm system 20 displays, on the terminal device 21 of the clerk, the traffic line of the customer holding the product to which the spare tag determined to be mismatched is attached in such a way as to be able to identify that mismatch is determined. As a result, the clerk can confirm the traffic line of the customer who may have shoplifted.

When the position of the spare tag and the position of the price label tag match, the alarm system 20 outputs that there is no problem. As a result, for example, the clerk can confirm that there is no abnormality.

The description of each example embodiment is ended. Each example embodiment may be modified. Hereinafter, a modification will be described.

### <Modification>

The second RFID tag included in the spare tag may store tag identification information for identifying the second RFID tag. The tag DB 2002 may store tag identification information for identifying the first RFID tag included in the price label tag of the product and tag identification information for identifying the second RFID included in the spare tag in association with each other.

The description of the modification is ended. Each example embodiment and each modification may be used in appropriate combination.

In each example embodiment, the alarm systems 10 and 20 may be configured to include each functional unit and a part of information.

The example embodiments are not limited to the examples described above, and various modifications can be made. The configurations of the alarm systems 10 and 20 according to the example embodiment are not particularly limited. For example, the alarm systems 10 and 20 may be achieved by one device such as one server. In a case where each functional unit of the alarm systems 10 and 20 is achieved by one device, for example, one device may be referred to as an alarm device, an information processing device, or the like, and is not particularly limited.

Alternatively, the alarm systems 10 and 20 in the example embodiments may be achieved by devices different for each function or data. For example, each functional unit may include a plurality of servers and be implemented as an alarm system. For example, the alarm systems 10 and 20 may be achieved by a database server including each database (DB) and a server including each functional unit. For example, the server implementing the alarm systems 10 and 20 may be an edge server managed in a store. The edge server may be further connected to a server that manages a plurality of stores such as the head office via the communication network NT. For example, the alarm systems 10 and 20 may be achieved by an edge server and a server that manages a plurality of stores.

For example, the output control units 103 and 203 may be achieved as a functional unit different for each device to be controlled.

In each example embodiment, each piece of information and each DB may include part of the information described above. Each piece of information and each DB may include information other than the above-described information. Each piece of information or each DB may be divided into a plurality of DBs or a plurality of pieces of information in more detail, or may be one DB.

Each screen is an example, and is not particularly limited. In each screen, a button, a list, a checkbox, an information display field, an input field, and the like (not illustrated) may be added. The background color of the screen and the like may be changed.

The processing of generating information or the like to be displayed on the terminal device 21 may be performed by the output control units 103 and 203. This processing may be performed by the terminal device.

### (Hardware Configuration Example of Computer)

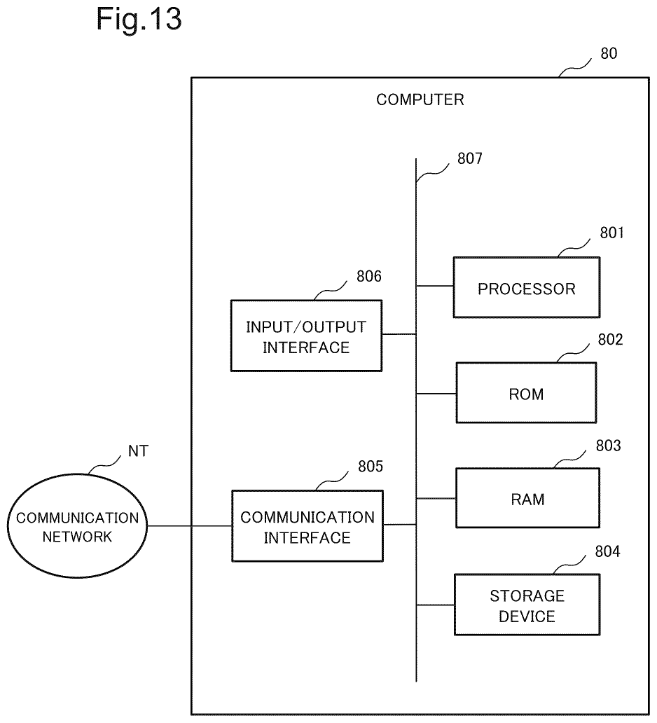

Next, a hardware configuration example in a case where each device such as the alarm systems 10 and 20 and the terminal device 21 described in each example embodiment is achieved by a computer will be described. FIG. 13 is an explanatory diagram illustrating an exemplary hardware configuration of a computer. For example, some or all of the devices can be achieved by using any combination of the computer 80 and the program as illustrated in FIG. 13.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. As the processor 801, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, a combination thereof, or the like can be used.

The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each processing coded in the program. The processor 801 may download various programs via the communication network NT. The processor 801 functions as part or all of the computer 80. The processor 801 may execute processing or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a voice output device that outputs voice. Examples of the input/output device include a touch panel display. The input device, the output device, the input/output device, and the like may be built in the computer 80 or may be externally attached.

The hardware configuration of the computer 80 is an example. The computer 80 may have some components shown in FIG. 13. The computer 80 may have components other than those illustrated in FIG. 13. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an image capturing device capable of capturing images and videos.

The description of the hardware configuration of each device is ended. There are various modifications in a method of achieving each device. For example, each device may be achieved by any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The alarm methods described in the example embodiments are implemented by the alarm systems 10 and 20. For example, the alarm method is implemented by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

Each component of the alarm systems 10 and 20 in each example embodiment described above may be achieved by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

An alarm system including:
a position detection means for detecting, by a reading device installed in a store, a position of a price label tag attached to a product and including a first RFID tag that stores product identification information of the product, and a position of a spare tag attached to the product and including a second RFID tag;
a determination means for determining whether the position of the price label tag and the position of the spare tag match; and
an output control means for issuing alarm in a case where the positions do not match.

### (Supplementary Note 2)

The alarm system according to Supplementary Note 1, in which the price label tag is a tag removable from the product.

### (Supplementary Note 3)

The alarm system according to Supplementary Note 1 or 2, in which
the spare tag is a tag that cannot be removed from the product.

### (Supplementary Note 4)

The alarm system according to any one of Supplementary Notes 1 to 3, in which
the spare tag is a laundry tag.

### (Supplementary Note 5)

The alarm system according to any one of Supplementary Notes 1 to 4, in which
the second RFID tag stores tag identification information for identifying the first RFID tag, and
the determination means determines whether the position of the spare tag matches the position of the price label tag including the first RFID tag identified by the tag identification information stored in the second RFID tag included in the spare tag.

### (Supplementary Note 6)

The alarm system according to any one of Supplementary Notes 1 to 5, in which
the output control means issues alarm to at least one of a terminal device of a clerk, a terminal device of a store near the spare tag, a terminal device of a store near the price label tag, and a terminal device near a display position of the product to which the price label tag is attached.

### (Supplementary Note 7)

The alarm system according to any one of Supplementary Notes 1 to 6, in which
the output control means issues alarm to a product registration device that performs product registration by an operation of a customer.

### (Supplementary Note 8)

The alarm system according to Supplementary Note 7, in which in a case where an alarm is issued to the product registration device, the output control means calls a clerk.

### (Supplementary Note 9)

The alarm system according to any one of Supplementary Notes 1 to 8, in which
the reading device is provided in a terminal device installed in a store and operable by a customer, and
the output control means issues alarm to the terminal device in a case where the positions do not match.

### (Supplementary Note 10)

The alarm system according to any one of Supplementary Notes 1 to 9, further including:
an image detection means for detecting a series of images before and after a time at which a mismatch is determined from an image captured by an image capturing device installed in the store; and
an identification means for identifying a customer having the product to which the spare tag is attached from the series of detected images,
in which the output control means issues alarm to at least one of a terminal device near the identified customer, a terminal device of the identified customer, and a terminal device that has authenticated the identified customer.

### (Supplementary Note 11)

The alarm system according to Supplementary Note 10, in which
the output control means issues alarm, as a recommended product, the product to which the spare tag determined to be mismatched is attached.

### (Supplementary Note 12)

The alarm system according to any one of Supplementary Notes 1 to 11, in which
the output control means issues alarm to an output device installed at an entrance of the store.

### (Supplementary Note 13)

The alarm system according to Supplementary Note 12, in which the reading device is installed at an entrance of the store.

### (Supplementary Note 14)

The alarm system according to any one of Supplementary Notes 1 to 13, further including:
an image detection means for detecting, in a case where the images do not match, a series of images before and after a time at which the mismatch is determined from the image captured by the image capturing device installed in the store; and
an association means for associating the time at which the mismatch is determined with the detected series of images.

### (Supplementary Note 15)

The alarm system according to Supplementary Note 14, in which
the output control means displays the time at which mismatch is determined and the series of detected images in association with each other on a terminal device of a clerk.

### (Supplementary Note 16)

The alarm system according to any one of Supplementary Notes 1 to 13, further including:
an image detection means for detecting a series of images before and after a time at which a mismatch is determined from an image captured by an image capturing device installed in the store; and
an identification means for identifying a customer having the product to which the spare tag is attached from the series of detected images,
in which the output control means displays, on a terminal device of a clerk, a traffic line of the identified customer in such a way as to be able to identify that mismatch is determined.

### (Supplementary Note 17)

The alarm system according to any one of supplementary Notes 1 to 16, in which
the output control means performs an output indicating that there is no problem in the case of matching.

### (Supplementary Note 18)

An alarm method including:
detecting, by a reading device installed in a store, a position of a price label tag attached to a product and including a first RFID tag that stores product identification information of the product and a position of a spare tag attached to the product and including a second RFID tag;
determining whether the position of the price label tag and the position of the spare tag match; and
issuing an alarm in a case where the positions do not match.

### (Supplementary Note 19)

A non-transitory computer-readable recording medium storing a program for causing a computer to execute processing of:
detecting, by a reading device installed in a store, a position of a price label tag attached to a product and including a first RFID tag that stores product identification information of the product and a position of a spare tag attached to the product and including a second RFID tag;
determining whether the position of the price label tag matches the position of the spare tag; and
issuing an alarm in a case where the positions do not match.

### (Supplementary Note 20)

A program causing a computer to execute processing of:
detecting, by a reading device installed in a store, a position of a price label tag attached to a product and including a first RFID tag that stores product identification information of the product and a position of a spare tag attached to the product and including a second RFID tag;
determining whether the position of the price label tag matches the position of the spare tag; and
issuing an alarm in a case where the positions do not match.

### REFERENCE SIGNS LIST

10, 20 alarm system
21 terminal device
22, 22-1, 22-2, 22-3, 22-4, 22-5, 22-6, 22-7, 22-8, 22-9, 22-10, 22-11, 22-12, 22-13, 22-14, 22-15, 22-16 reading device
23, 23-1, 23-2, 23-3, 23-4, 23-5 image capturing device
24 voice output device
80 computer
101, 201 position detection unit
102, 202 determination unit
103, 203 output control unit
204 image detection unit
205 identification unit
206 associated portion
207 authentication unit
801 processor
802 ROM
803 RAM
804 storage device
805 communication interface
806 input/output interface
807 bus
2001 product DB
2002 tag DB
2003 stolen product DB
2004 action history DB
2005 customer DB
NT communication network

What is claimed is:

1. An alarm system comprising:
at least one memory storing instructions; and
at least one processor configured to execute the instructions to:
detect, by a reading device installed in a store, a position of a price label tag attached to a product and including a first radio frequency identification (RFID) tag that stores product identification information of the product, and a position of a spare tag attached to the product and including a second RFID tag;
determine whether the position of the price label tag and the position of the spare tag match; and
issue an alarm in a case where the position of the price label tag and the position of the spare tag do not match.

2. The alarm system according to claim 1, wherein
the price label tag is a tag removable from the product.

3. The alarm system according to claim 1, wherein
the spare tag is a tag that cannot be removed from the product.

4. The alarm system according to claim 1, wherein
the spare tag is a laundry tag.

5. The alarm system according to claim 1, wherein
the second RFID tag stores tag identification information for identifying the first RFID tag, and the at least one processor is further configured to execute the instructions to:
determine whether the position of the spare tag matches the position of the price label tag including the first RFID tag identified by the tag identification information stored in the second RFID tag included in the spare tag.

6. The alarm system according to claim 1, wherein the at least one processor is further configured to execute the instructions to:
issue alarm to at least one of a terminal device of a clerk, a terminal device of a store near the spare tag, a terminal device of a store near the price label tag, and a terminal device near a display position of the product to which the price label tag is attached.

7. The alarm system according to claim 1, wherein the at least one processor is further configured to execute the instructions to:
issue alarm to a product registration device that performs product registration by an operation of a customer.

8. The alarm system according to claim 7, wherein the at least one processor is further configured to execute the instructions to:
call a clerk in a case where an alarm is issued to the product registration device.

9. The alarm system according to claim 1, wherein
the reading device is provided in a terminal device installed in a store and operable by a customer, and the at least one processor is further configured to execute the instructions to:
issue alarm to the terminal device in a case where the position of the price label tag and the position of the spare tag do not match.

10. The alarm system according to claim 1, wherein the at least one processor is further configured to execute the instructions to:
detect a series of images before and after a time at which a mismatch is determined from an image captured by an image capturing device installed in the store; and
identify a customer having the product to which the spare tag is attached from the series of detected images; and
issue alarm to at least one of a terminal device near the identified customer, a terminal device of the identified customer, and a terminal device that has authenticated the identified customer.

11. The alarm system according to claim 10, wherein the at least one processor is further configured to execute the instructions to:
issue alarm, as a recommended product, the product to which the spare tag determined to be mismatched is attached.

12. The alarm system according to claim 1, wherein the at least one processor is further configured to execute the instructions to:
issue alarm to an output device installed at an entrance of the store.

13. The alarm system according to claim 12, wherein
the reading device is installed at an entrance of the store.

14. The alarm system according to claim 1,
wherein the at least one processor is further configured to execute the instructions to:
detect, in a case where the images do not match, a series of images before and after a time at which the mismatch is determined from the image captured by the image capturing device installed in the store; and
associate the time at which the mismatch is determined with the detected series of images.

15. The alarm system according to claim 14, wherein the at least one processor is further configured to execute the instructions to:
display the time at which mismatch is determined and the series of detected images in association with each other on a terminal device of a clerk.

16. The alarm system according to claim 1, wherein the at least one processor is further configured to execute the instructions to:
detect a series of images before and after a time at which a mismatch is determined from an image captured by an image capturing device installed in the store; and
identify a customer having the product to which the spare tag is attached from the series of detected images; and
display, on a terminal device of a clerk, a traffic line of the identified customer in such a way as to be able to identify that mismatch is determined.

17. The alarm system according to claim 1, wherein the at least one processor is further configured to execute the instructions to:
perform an output indicating that there is no problem in the case of matching.

18. An alarm method comprising:
detecting, by a reading device installed in a store, a position of a price label tag attached to a product and including a first RFID tag that stores product identification information of the product and a position of a spare tag attached to the product and including a second RFID tag;
determining whether the position of the price label tag and the position of the spare tag match; and
issuing an alarm in a case where the position of the price label tag and the position of the spare tag do not match.

19. A non-transitory computer-readable recording medium storing a program for causing a computer to execute processing of:
detecting, by a reading device installed in a store, a position of a price label tag attached to a product and including a first RFID tag that stores product identification information of the product and a position of a spare tag attached to the product and including a second RFID tag;
determining whether the position of the price label tag matches the position of the spare tag; and
issuing an alarm in a case where the position of the price label tag and the position of the spare tag do not match.
